(19) United States
(12) Patent Application Publication
(10) Pub. No.: US 2026/0221027 A1
(43) Pub. Date: Jul. 30, 2026

(54) Adaptive Cruise Control Target Speed Tuning

(71) Applicant: Nissan North America, Inc., Franklin, TN (US)

(72) Inventors: Xin Yang, East Palo Alto, CA (US); Yuxuan Li, Champaign, IL (US); Hirotaka Kamimura, San Jose, CA (US); Katsuhiko Hirayama, Cupertino, CA (US)

(21) Appl. No.: 19/040,489

(22) Filed: Jan. 29, 2025

(51) Int. Cl. G08G 1/01; B60W 30/16

(52) U.S. Cl. CPC G08G 1/0145; B60W 30/162

(57) ABSTRACT

A system and method for determining improved target speeds for accelerated cruise control systems of vehicles. Data is obtained by human-operated ego vehicles, the data including ego-vehicle speeds, lead-vehicle speeds, follow distances, and location tuples of the ego vehicles, such as GNSS coordinates. The location tuples are mapped to lane centerpoints of a high-definition map. A machine-learning model is trained to determine target speeds of a future vehicle based on the ego-vehicle speeds, lead-vehicle speeds, follow distances, and lane centerpoints. The trained model can be implemented as part of an accelerated cruise control system in a vehicle.

### TECHNICAL FIELD

This disclosure relates generally to adaptive cruise control, and more specifically, to systems and methods for determining and implementing improved target speeds based on a machine-learning model trained on vehicle-speed data acquired vehicles operated by in-cabin human drivers.

### BACKGROUND

Traditional cruise control systems have long been used in vehicles to maintain a constant speed set by a driver. While effective for reducing driver fatigue and improving fuel efficiency on long, uninterrupted stretches of road, these systems are often unable to respond dynamically to changing traffic conditions or driver preferences. To address these limitations, adaptive cruise control systems, including those with acceleration management capabilities, have been developed to provide a more responsive and adaptive driving experience.

Adaptive cruise control (ACC) builds upon traditional cruise control by integrating advanced sensing technologies and control algorithms to dynamically adjust the vehicle's speed. By utilizing inputs from lidar, radar, cameras. and other sensors, the system can monitor relative speeds of and distances to leading vehicles, automatically accelerating or decelerating to maintain a safe following distance. This enables a more seamless and intuitive driving experience, particularly in stop-and-go traffic or on congested highways. Additionally, ACC can serve as a foundational component for higher levels of vehicle automation, such as semi-autonomous or autonomous driving technologies.

### SUMMARY

In certain embodiments, ACC may include advanced features such as adjusting vehicle speed based on one or more of: curvature of the road (in a plan view), cross slope of the road (perpendicular to the primary direction of travel), along slope of the road (parallel to the primary direction of travel), lane type (e.g., driving lane, overtaking lane, deceleration lane, etc.), lane width (e.g., distance between lane markers), lane length, and speed limit. Many or all of these parameters may be obtained from high-definition map (HDMAP) data, for example, like those provided by companies like Zenrin and Ushr. In certain embodiments, ACC may include additional advanced features such as adjusting vehicle speed based on one or more of a speed of a lead vehicle (e.g., an absolute or relative speed of a vehicle that is ahead and approximately in a same lane as an ego vehicle) and a distance to the lead vehicle. Embodiments like those described above may provide for increased comfort of in-cabin occupants and enhanced safety.

Specifically, disclosed herein are aspects, features, elements, implementations, and embodiments of a method, a system, and a non-transitory computer-readable medium for determining improved target (e.g., optimal) speeds for ACC systems of vehicles.

A first aspect of the disclosed implementations is a method that includes the steps of: obtaining a high-definition map (HDMAP) corresponding to a length of road; obtaining, from ego vehicles on the length of road and operated by in-cabin human drivers: speeds of the ego vehicles, relative speeds of lead vehicles ahead of the ego vehicles, follow distances of the ego vehicles to the lead vehicles, and location tuples of the ego vehicles; mapping the location tuples of the ego vehicles to lane centerpoints on the HDMAP; and training a machine-learning (ML) model to determine target speeds of a future vehicle based on: the speeds of the ego vehicles, the relative speeds of the lead vehicles, the follow distances of the ego vehicles, and the lane centerpoints on the HDMAP.

A second aspect of the disclosed implementations is a system that includes one or more memories and one or more processors configured to execute instructions stored in the one or more memories to implement the steps of the method described above.

A third aspect of the disclosed implementations is a non-transitory computer-readable medium storing instructions operable to cause one or more processors to perform operations according to the steps of the method described above.

As used herein, the term “vehicles” encompasses driver-operated vehicles and semi-autonomous or autonomous vehicles (which may be referred to as self-driving vehicles) and similar terms unless stated otherwise or indicated by context.

### BRIEF DESCRIPTION OF THE DRAWINGS

The various aspects of the methods and systems disclosed herein will become more apparent by referring to the examples provided in the following description and drawings in which like reference numbers refer to like elements unless otherwise noted.

FIG. 1 is a diagram of an example of a portion of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 is a block diagram of an example internal configuration of a computing device of an electronic computing and communications system in which the aspects, features, and elements disclosed herein may be implemented.

FIG. 4 is a diagram of an example of a system for obtaining training data from vehicles operated by in-cabin drivers, for training an ML model, and for implementing the ML model to adjust a speed of a vehicle in ACC mode.

FIG. 5 is a diagram of an example of a framework for mapping global navigation satellite system (GNSS) location datapoints to lane centerpoints of an HDMAP.

FIG. 6 is a flowchart of an example of a process for training an ML model to determine target speeds of a vehicle for use in an ACC mode.

### DETAILED DESCRIPTION

To describe some implementations in greater detail, reference is made to the following figures.

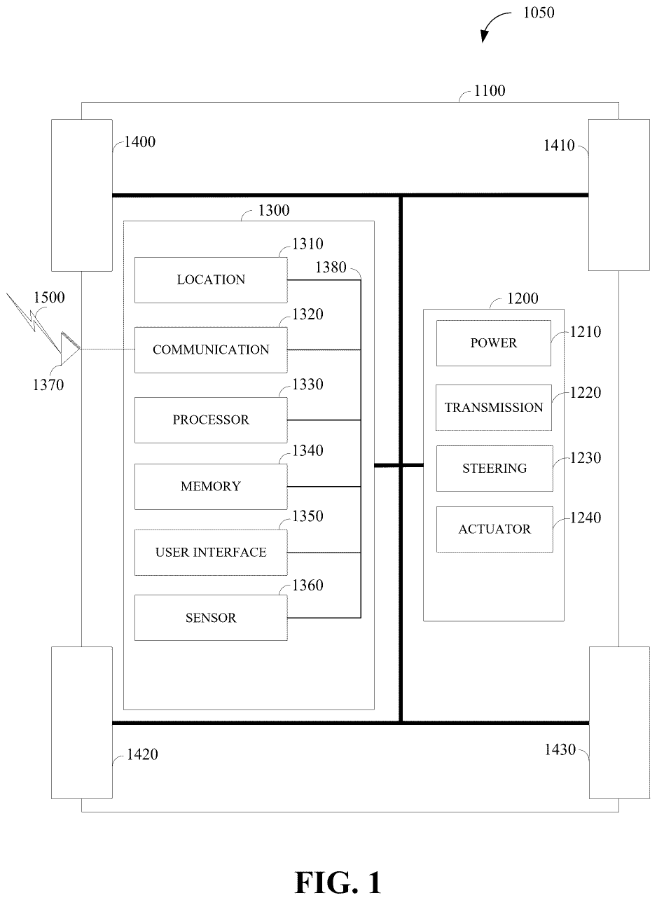

FIG. 1 is a diagram of an example of a vehicle 1050 in which the aspects, features, and elements disclosed herein may be implemented. The vehicle 1050 may include a chassis 1100, a powertrain 1200, a controller 1300, wheels 1400/1410/1420/1430, or any other element or combination of elements of a vehicle. Although the vehicle 1050 is shown as including four wheels 1400/1410/1420/1430 for simplicity, any other propulsion device or devices, such as a propeller or tread, may be used. In FIG. 1, the lines interconnecting elements, such as the powertrain 1200, the controller 1300, and the wheels 1400/1410/1420/1430, indicate that information, such as data or control signals, power, such as electrical power or torque, or both information and power, may be communicated between the respective elements. For example, the controller 1300 may receive power from the powertrain 1200 and communicate with the powertrain 1200, the wheels 1400/1410/1420/1430, or both, to control the vehicle 1050, which can include accelerating, decelerating, steering, or otherwise controlling the vehicle 1050.

The powertrain 1200 includes a power source 1210, a transmission 1220, a steering unit 1230, a vehicle actuator 1240, or any other element or combination of elements of a powertrain, such as a suspension, a drive shaft, axles, or an exhaust system. Although shown separately, the wheels 1400/1410/1420/1430 may be included in the powertrain 1200. A braking system may be included in the vehicle actuator 1240.

The power source 1210 may be any device or combination of devices operative to provide energy, such as electrical energy, chemical energy, or thermal energy. For example, the power source 1210 includes an engine, such as an internal combustion engine, an electric motor, or a combination of an internal combustion engine and an electric motor, and is operative to provide energy as a motive force to one or more of the wheels 1400/1410/1420/1430. In some embodiments, the power source 1210 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 1220 receives energy from the power source 1210 and transmits the energy to the wheels 1400/1410/1420/1430 to provide a motive force. The transmission 1220 may be controlled by the controller 1300, the vehicle actuator 1240 or both. The steering unit 1230 may be controlled by the controller 1300, the vehicle actuator 1240, or both and controls the wheels 1400/1410/1420/1430 to steer the vehicle. The vehicle actuator 1240 may receive signals from the controller 1300 and may actuate or control the power source 1210, the transmission 1220, the steering unit 1230, or any combination thereof to operate the vehicle 1050.

In some embodiments, the controller 1300 includes a location unit 1310, an electronic communication unit 1320, a processor 1330, a memory 1340, a user interface 1350, a sensor 1360, an electronic communication interface 1370, or any combination thereof. Although shown as a single unit, any one or more elements of the controller 1300 may be integrated into any number of separate physical units. For example, the user interface 1350 and processor 1330 may be integrated in a first physical unit and the memory 1340 may be integrated in a second physical unit. Although not shown in FIG. 1, the controller 1300 may include a power source, such as a battery. Although shown as separate elements, the location unit 1310, the electronic communication unit 1320, the processor 1330, the memory 1340, the user interface 1350, the sensor 1360, the electronic communication interface 1370, or any combination thereof can be integrated in one or more electronic units, circuits, or chips.

In some embodiments, the processor 1330 includes any device or combination of devices capable of manipulating or processing a signal or other information now existing or hereafter developed, including optical processors, quantum processors, molecular processors, or a combination thereof. For example, the processor 1330 may include one or more special purpose processors, one or more digital signal processors, one or more microprocessors, one or more controllers, one or more microcontrollers, one or more integrated circuits, one or more an application-specific integrated circuits (ASICs), one or more field-programmable gate arrays (FPGAs), one or more programmable logic arrays (PLAs), one or more programmable logic controllers (PLCs), one or more state machines, or any combination thereof. The processor 1330 may be operatively coupled with the location unit 1310, the memory 1340, the electronic communication interface 1370, the electronic communication unit 1320, the user interface 1350, the sensor 1360, the powertrain 1200, or any combination thereof. For example, the processor may be operatively coupled with the memory 1340 via a communication bus 1380.

In some embodiments, the processor 1330 may be configured to execute instructions including instructions for remote operation which may be used to operate the vehicle 1050 from a remote location including a data-processing center. The instructions for remote operation may be stored in the vehicle 1050 or received from an external source such as a traffic management center, or server computing devices, which may include cloud-based server computing devices. The processor 1330 may be configured to execute instructions for following a projected path as described herein.

The memory 1340 may include any tangible non-transitory computer-usable or computer-readable medium, capable of, for example, containing, storing, communicating, or transporting machine readable instructions or any information associated therewith, for use by or in connection with the processor 1330. The memory 1340 is, for example, one or more solid state drives, one or more memory cards, one or more removable media, one or more read only memories, one or more random access memories, one or more solid-state drives, one or more disks, including a hard disk, a floppy disk, an optical disk, a magnetic or optical card, or any type of non-transitory media suitable for storing electronic information, or any combination thereof.

The electronic communication interface 1370 may be a wireless antenna, as shown, a wired communication port, an optical communication port, or any other wired or wireless unit capable of interfacing with a wired or wireless electronic communication medium 1500.

The electronic communication unit 1320 may be configured to transmit or receive signals via the wired or wireless electronic communication medium 1500, such as via the electronic communication interface 1370. Although not explicitly shown in FIG. 1, the electronic communication unit 1320 is configured to transmit, receive, or both via any wired or wireless communication medium, such as radio frequency (RF), ultraviolet (UV), visible light, fiber optic, wire line, or a combination thereof. Although FIG. 1 shows a single one of the electronic communication unit 1320 and a single one of the electronic communication interface 1370, any number of communication units and any number of communication interfaces may be used. In some embodiments, the electronic communication unit 1320 can include a dedicated short-range communications (DSRC) unit, a wireless safety unit (WSU), IEEE 802.11p (WiFi-P), a cellular communication unit such as a long-term evolution (LTE) or 5G transceiver, or a combination thereof.

The location unit 1310 may determine geolocation information, including but not limited to longitude, latitude, elevation, direction of travel, or speed, of the vehicle 1050. For example, the location unit includes a global navigation satellite system (GNSS) unit (e.g., a global positioning system (GPS) unit), a wide area augmentation system (WAAS) enabled National Marine-Electronics Association (NMEA) unit, a radio triangulation unit, or a combination thereof. The location unit 1310 can be used to obtain information that represents, for example, a current heading of the vehicle 1050, a current position of the vehicle 1050 in two or three dimensions, a current angular orientation of the vehicle 1050, or a combination thereof.

The user interface 1350 may include any unit capable of being used as an interface by a person, including any of a virtual keypad, a physical keypad, a touchpad, a display, a touchscreen, a speaker, a microphone, a video camera, a sensor, and a printer. The user interface 1350 may be operatively coupled with the processor 1330, as shown, or with any other element of the controller 1300. Although shown as a single unit, the user interface 1350 can include one or more physical units. For example, the user interface 1350 includes an audio interface for performing audio communication with a person, and a touch display for performing visual and touch based communication with the person.

The sensor 1360 may include one or more sensors, such as an array of sensors, which may be operable to provide information that may be used to control the vehicle. The sensor 1360 can provide information regarding current operating characteristics of the vehicle or its surrounding. The sensors 1360 include, for example, a speed sensor, acceleration sensors, a steering angle sensor, traction-related sensors, braking-related sensors, or any sensor, or combination of sensors, that is operable to report information regarding some aspect of the current dynamic situation of the vehicle 1050.

In some embodiments, the sensor 1360 may include sensors that are operable to obtain information regarding the physical environment within or surrounding the vehicle 1050. With regard to within the vehicle 1050, e.g., the in-cabin environment, one or more sensors may detect objects within the vehicle, such as groceries, electronic devices, pets, people, in-vehicle controls, and so on. With respect to surrounding the vehicle, e.g., the external, exterior, or outside environment, one or more sensors may detect road geometry and obstacles, such as fixed obstacles, vehicles, cyclists, and pedestrians. In some embodiments, the sensor 1360 can be or include one or more still or video cameras, laser-sensing systems, infrared-sensing systems, acoustic-sensing systems, or any other suitable type of on-vehicle environmental sensing device, or combination of devices, now known or later developed. In some embodiments, the sensor 1360 and the location unit 1310 are combined.

Although not shown separately, the vehicle 1050 may include a trajectory controller. For example, the controller 1300 may include a trajectory controller. The trajectory controller may be operable to obtain information describing a current state of the vehicle 1050 and a route planned for the vehicle 1050, and, based on this information, to determine and optimize a trajectory for the vehicle 1050. In some embodiments, the trajectory controller outputs signals operable to control the vehicle 1050 such that the vehicle 1050 follows the trajectory that is determined by the trajectory controller. For example, the output of the trajectory controller can be an optimized trajectory that may be supplied to the powertrain 1200, the wheels 1400/1410/1420/1430, or both. In some embodiments, the optimized trajectory can control inputs such as a set of steering angles, with each steering angle corresponding to a point in time or a position. In some embodiments, the optimized trajectory can be one or more paths, lines, curves, or a combination thereof.

One or more of the wheels 1400/1410/1420/1430 may be a steered wheel, which is pivoted to a steering angle under control of the steering unit 1230, a propelled wheel, which is torqued to propel the vehicle 1050 under control of the transmission 1220, or a steered and propelled wheel that steers and propels the vehicle 1050.

A vehicle may include units, or elements not shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

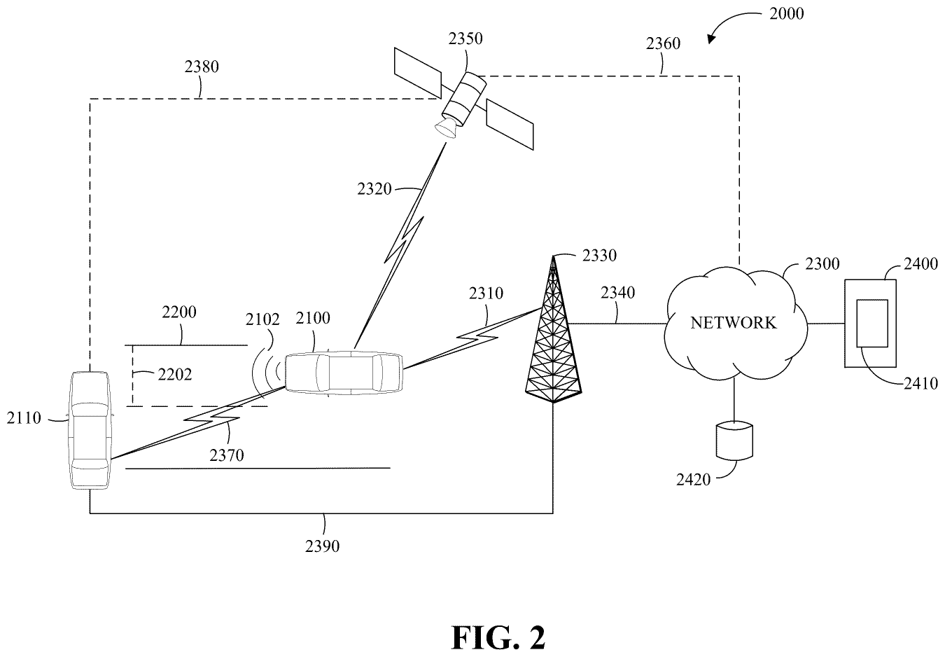

FIG. 2 is a diagram of an example of a portion of a vehicle transportation and communication system 2000 in which the aspects, features, and elements disclosed herein may be implemented. The vehicle transportation and communication system 2000 includes a vehicle 2100, such as the vehicle 1050 shown in FIG. 1, and one or more external objects, such as an external object 2110, which can include any form of transportation, such as the vehicle 1050 shown in FIG. 1, a pedestrian, cyclist, as well as any form of a structure, such as a building. The vehicle 2100 may travel via one or more portions of a transportation network 2200, and may communicate with the external object 2110 via one or more of an electronic communication network 2300. Although not explicitly shown in FIG. 2, a vehicle may traverse an area that is not expressly or completely included in a transportation network, such as an off-road area. In some embodiments the transportation network 2200 may include one or more of a vehicle detection sensor 2202, such as an inductive loop sensor, which may be used to detect the movement of vehicles on the transportation network 2200.

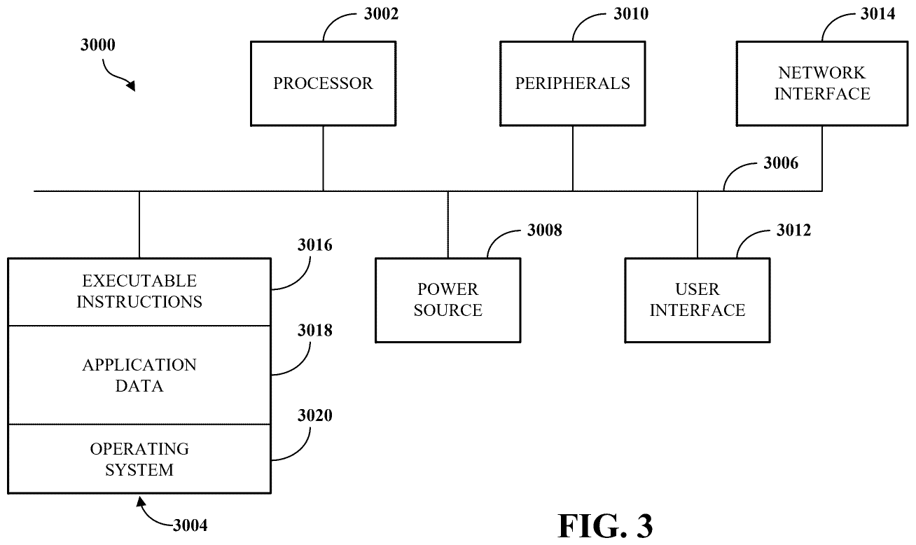

The electronic communication network 2300 may be a multiple-access system that provides for communication, such as voice communication, data communication, video communication, messaging communication, or a combination thereof, between the vehicle 2100, the external object 2110, and a data-processing center 2400. For example, the vehicle 2100 or the external object 2110 may send information to, or receive information from, the data-processing center 2400 or a database server 2420, via the electronic communication network 2300, such as information representing the transportation network 2200. The data-processing center 2400 includes a computing apparatus 2410, that includes some or all of the features of the computing device 3000 shown in FIG. 3, which is described later herein. In some implementations, the data-processing center 2400 includes the database server 2420. The database server 2420 is configured for storing data, and it may be implemented by a suitable computer storage medium.

The data-processing center 2400 can monitor and coordinate the movement of vehicles, including autonomous vehicles. The data-processing center 2400 may monitor the state or condition of vehicles, such as the vehicle 2100, and external objects, such as the external object 2110. The data-processing center 2400 can receive vehicle data and infrastructure data including any of: vehicle velocity; vehicle location; vehicle operational state; vehicle destination; vehicle route; vehicle sensor data; external object velocity; external object location; external object operational state; external object destination; external object route; and external object sensor data.

Further, the data-processing center 2400 can establish remote control over one or more vehicles, such as the vehicle 2100, or external objects, such as the external object 2110. In this way, the data-processing center 2400 may tele-operate the vehicles or external objects from a remote location. The computing apparatus 2410 may exchange (send or receive) state data with vehicles, external objects, or computing devices such as the vehicle 2100, the external object 2110, or the database server 2420, via a wireless communication link such as the wireless communication link 2380 or a wired communication link such as the wired communication link 2390.

In some embodiments, the vehicle 2100 or the external object 2110 communicates via the wired communication link 2390, a wireless communication link 2310/2320/2370, or a combination of any number or types of wired or wireless communication links. For example, as shown, the vehicle 2100 or the external object 2110 communicates via a terrestrial wireless communication link 2310, via a non-terrestrial wireless communication link 2320, or via a combination thereof. In some implementations, a terrestrial wireless communication link 2310 includes an Ethernet link, a serial link, a Bluetooth link, an infrared (IR) link, an ultraviolet (UV) link, or any link capable of providing for electronic communication.

A vehicle, such as the vehicle 2100, or an external object, such as the external object 2110, may communicate with another vehicle, external object, or the data-processing center 2400. For example, a host, or subject, vehicle 2100 may receive one or more automated inter-vehicle messages, such as a basic safety message (BSM), from the data-processing center 2400, via a direct communication link 2370, or via an electronic communication network 2300. For example, data-processing center 2400 may broadcast the message to host vehicles within a defined broadcast range, such as three hundred meters, or to a defined geographical area. In some embodiments, the vehicle 2100 receives a message via a third party, such as a signal repeater (not shown) or another remote vehicle (not shown). In some embodiments, the vehicle 2100 or the external object 2110 transmits one or more automated inter-vehicle messages periodically based on a defined interval, such as one hundred milliseconds.

Automated inter-vehicle messages may include vehicle identification information, geospatial state information, such as longitude, latitude, or elevation information, geospatial location accuracy information, kinematic state information, such as vehicle acceleration information, yaw rate information, speed information, vehicle heading information, braking system state data, throttle information, steering wheel angle information, or vehicle routing information, or vehicle operating state information, such as vehicle size information, headlight state information, turn signal information, wiper state data, transmission information, or any other information, or combination of information, relevant to the transmitting vehicle state. For example, transmission state information indicates whether the transmission of the transmitting vehicle is in a neutral state, a parked state, a forward state, or a reverse state.

In some embodiments, the vehicle 2100 communicates with the electronic communication network 2300 via an access point 2330. The access point 2330, which may include a computing device, may be configured to communicate with the vehicle 2100, with the electronic communication network 2300, with the data-processing center 2400, or with a combination thereof via wired or wireless communication links 2310/2340. For example, an access point 2330 is a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point can include any number of interconnected elements.

The vehicle 2100 may communicate with the electronic communication network 2300 via a satellite 2350, or other non-terrestrial communication device. The satellite 2350, which may include a computing device, may be configured to communicate with the vehicle 2100, with the electronic communication network 2300, with the data-processing center 2400, or with a combination thereof via one or more communication links 2320/2360. Although shown as a single unit, a satellite can include any number of interconnected elements.

The electronic communication network 2300 may be any type of network configured to provide for voice, data, or any other type of electronic communication. For example, the electronic communication network 2300 includes a local area network (LAN), a wide area network (WAN), a virtual private network (VPN), a mobile or cellular telephone network, the Internet, or any other electronic communication system. The electronic communication network 2300 may use a communication protocol, such as the transmission control protocol (TCP), the user datagram protocol (UDP), the internet protocol (IP), the real-time transport protocol (RTP) the Hyper Text Transport Protocol (HTTP), or a combination thereof. Although shown as a single unit, an electronic communication network can include any number of interconnected elements.

In some embodiments, the vehicle 2100 communicates with the data-processing center 2400 via the electronic communication network 2300, access point 2330, or satellite 2350. The data-processing center 2400 may include one or more computing devices, which are able to exchange (send or receive) data from: vehicles such as the vehicle 2100; external objects including the external object 2110; or storage devices such as the database server 2420.

In some embodiments, the vehicle 2100 identifies a portion or condition of the transportation network 2200. For example, the vehicle 2100 may include one or more on-vehicle sensors 2102, such as the sensor 1360 shown in FIG. 1, which includes a speed sensor, a wheel speed sensor, a camera, a gyroscope, an optical sensor, a laser sensor, a radar sensor, a sonic sensor (e.g., a microphone or acoustic sensor), a compass, or any other sensor or device or combination thereof capable of determining or identifying a portion or condition of the transportation network 2200.

The vehicle 2100 may traverse one or more portions of the transportation network 2200 using information communicated via the electronic communication network 2300, such as information representing the transportation network 2200, information identified by one or more on-vehicle sensors 2102, or a combination thereof. The external object 2110 may be capable of all or some of the communications and actions described above with respect to the vehicle 2100.

For simplicity, FIG. 2 shows the vehicle 2100 as the host vehicle, the external object 2110, the transportation network 2200, the electronic communication network 2300, and the data-processing center 2400. However, any number of vehicles, networks, or computing devices may be used. In some embodiments, the vehicle transportation and communication system 2000 includes devices, units, or elements not shown in FIG. 2. Although the vehicle 2100 or external object 2110 is shown as a single unit, a vehicle can include any number of interconnected elements.

Although the vehicle 2100 is shown communicating with the data-processing center 2400 via the electronic communication network 2300, the vehicle 2100 (and external object 2110) may communicate with the data-processing center 2400 via any number of direct or indirect communication links. For example, the vehicle 2100 or external object 2110 may communicate with the data-processing center 2400 via a direct communication link, such as a Bluetooth communication link. Although, for simplicity, FIG. 2 shows one of the transportation network 2200, and one of the electronic communication network 2300, any number of networks or communication devices may be used. The vehicle 2100 (and external object 2110) can be monitored or coordinated by the data-processing center 2400, can be operated autonomously or by a human driver, and can exchange (send and receive) vehicle data relating to the state or condition of the vehicle and its surroundings including any of vehicle velocity (e.g., vehicle speed and vehicle trajectory, or heading); vehicle location; vehicle operational state; vehicle destination; vehicle route; vehicle sensor data; external object velocity; external object location, and so on.

FIG. 3 shows a block diagram of an example of a computing device 3000 in which certain aspects, features, and elements disclosed herein may be implemented. The computing device 3000 may be, for example, the controller 1300 shown in FIG. 1 or the computing apparatus 2410 shown in FIG. 2. The computing device 3000 includes components or units, such as a processor 3002, a memory 3004, a bus 3006, a power source 3008, peripherals 3010, a user interface 3012, a network interface 3014, other suitable components, or a combination thereof. One or more of the memory 3004, the power source 3008, the peripherals 3010, the user interface 3012, or the network interface 3014 can communicate with the processor 3002 via the bus 3006.

The processor 3002 is a central processing unit, such as a microprocessor, and can include single or multiple processors having single or multiple processing cores. Alternatively, the processor 3002 can include another type of device, or multiple devices, configured for manipulating or processing information. For example, the processor 3002 can include multiple processors interconnected in one or more manners, including hardwired or networked. The operations of the processor 3002 can be distributed across multiple devices or units that can be coupled directly or across a local area or other suitable type of network. The processor 3002 can include a cache, or cache memory, for local storage of operating data or instructions.

The memory 3004 includes one or more memory components, which may each be volatile memory or non-volatile memory. For example, the volatile memory can be random access memory (RAM) (e.g., a DRAM module, such as DDR SDRAM). In another example, the non-volatile memory of the memory 3004 can be a disk drive, a solid state drive, flash memory, or phase-change memory. In some implementations, the memory 3004 can be distributed across multiple devices. For example, the memory 3004 can include network-based memory or memory in multiple clients or servers performing the operations of those multiple devices.

The memory 3004 can include data for immediate access by the processor 3002. For example, the memory 3004 can include executable instructions 3016, application data 3018, and an operating system 3020. The executable instructions 3016 can include one or more application programs, which can be loaded or copied, in whole or in part, from non-volatile memory to volatile memory to be executed by the processor 3002. For example, the executable instructions 3016 can include instructions for performing techniques of this disclosure. In some implementations, the application data 3018 can include functional programs, such as a computational programs, analytical programs, database programs, and so on. The operating system 3020 can be, for example, Microsoft Windows®, Mac OS X®, or Linux®; an operating system for a mobile device, such as a smartphone or tablet device; or an operating system for a non-mobile device, such as a mainframe computer.

The power source 3008 provides power to the computing device 3000. For example, the power source 3008 can be an interface to an external power distribution system. In another example, the power source 3008 can be a battery, such as where the computing device 3000 is a mobile device or is otherwise configured to operate independently of an external power distribution system. In some implementations, the computing device 3000 may include or otherwise use multiple power sources. In some such implementations, the power source 3008 can be a backup battery.

The peripherals 3010 may include one or more sensors, detectors, or other devices configured for monitoring the computing device 3000 or the environment around the computing device 3000. For example, the peripherals 3010 can include a geolocation component, such as a GNSS location unit (e.g., GPS). In another example, the peripherals can include a temperature sensor for measuring temperatures of components of the computing device 3000, such as the processor 3002. In some implementations, the computing device 3000 can omit the peripherals 3010.

The user interface 3012 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 3014 provides a connection or link to a network (e.g., the electronic communication network 2300 shown in FIG. 2). The network interface 3014 can be a wired network interface or a wireless network interface. The computing device 3000 can communicate with other devices via the network interface 3014 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof. For example, the computing device 3000 can communicate with a database server, such as the database server 2420 of FIG. 2.

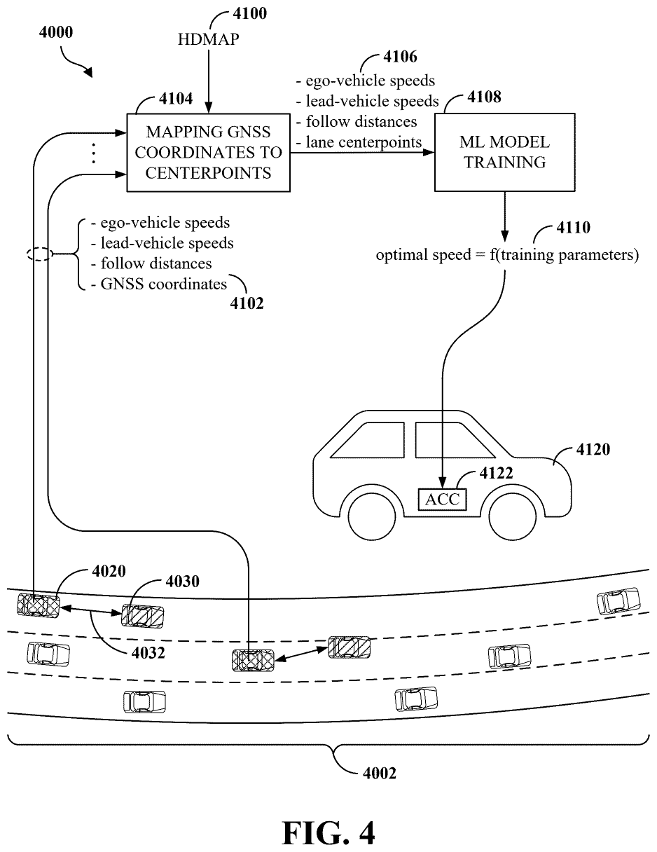

FIG. 4 is a diagram of an example of a system 4000 for obtaining data 4102 from at least one ego vehicle 4020 operated by an in-cabin driver, for training an ML model, and for executing the ML model to determine a target speed, e.g., an optimal speed 4110, of a vehicle 4120 whose speed is controlled by an ACC system 4122. The ego vehicle 4020 may be the vehicle 1050 of FIG. 1. While the ego vehicle may be capable of operating in a driver-assist, semi-autonomous, or autonomous driving mode, it is operated by an in-cabin driver while providing the data 4102. For example, the ego vehicle 4020 may always collect and provide data to the system 4000, including data that indicates a mode of operation (e.g., manual, semi-autonomous, or autonomous), and the system 4000 may utilize the data for training the ML model only if the mode of operation is manual.

The ego vehicle 4020 is operated by an in-cabin driver who determines and approximately maintains a follow distance 4032 behind a lead vehicle 4030 based on the driver's own assessments of the situation in the length of road 4002 and his own comfort levels. Sometimes the ego vehicle 4020 may drive behind the lead vehicle 4030, sometimes the ego vehicle 4020 may drive behind a different lead vehicle, and sometimes the ego vehicle 4020 may not drive behind any vehicle at all. A range of values of the follow distance 4032 (or simply distance 4032) for which the ego vehicle 4020 may be said to be “driving behind” or “following” the lead vehicle 4030 is known in the art. For example, the ego vehicle 4020 that trails the lead vehicle 4030 by one mile would not be considered to be driving behind or following the lead vehicle at speeds that are practical for conventional passenger vehicles on the road.

The data 4102 obtained by the ego vehicle 4020 includes a speed of the ego vehicle 4020, a speed of the lead vehicle 4030, the follow distance 4032, and GNSS coordinates of the ego vehicle 4020. The data 4102 may be obtained by various sensors of the ego vehicle 4120, such as the sensor 1360 of FIG. 1 to obtain the speed of the ego vehicle 4020, the speed of the lead vehicle 4030, and the follow distance 4132. In some implementations, the speed of the ego vehicle 4020 may be obtained by a vehicle speed sensor (VSS). In some implementations, the speed of the lead vehicle 4030 may be obtained by at least one of a lidar sensor, a radar sensor, a sonar sensor, an ultrasonic sensor, an infrared sensors, or an optical camera. The speed of the lead vehicle 4030 may be relative to the speed of the ego vehicle 4020, e.g., a relative speed, or it may be an absolute speed of the lead vehicle 4030, where both relative and absolute speeds of the lead vehicle 4030 may be used interchangeably herein unless dictated otherwise by context or explicitly. In some implementations, the follow distance 4032 may be obtained by at least one of a lidar sensor, a radar sensor, a sonar sensor, an ultrasonic sensor, an infrared sensors, or an optical camera. The data 4102 may be obtained by additional various sensors of the ego vehicle 4120, such as the location unit 1310 of FIG. 1 to obtain the GNSS coordinates, e.g., GPS coordinates. The data 4102 may be collected at a suitable sample frequency, such as 100 Hz. For example, the data 4102 may comprises an updated set of values of ego-vehicle speed, lead-vehicle speed, follow distance, and GNSS coordinates every 1/100 Hz=0.01 s.

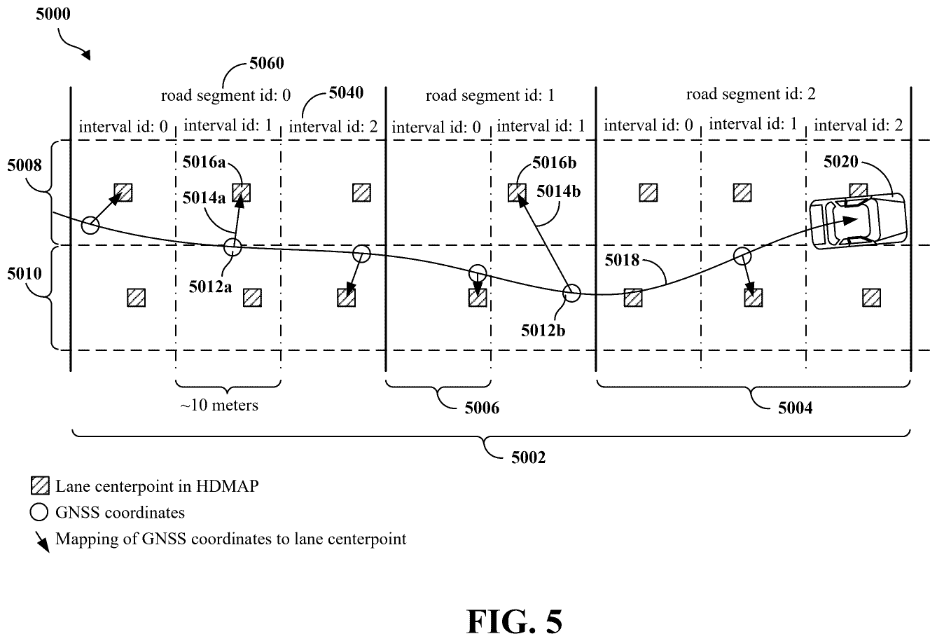

The GNSS coordinates are mapped to points on an HDMAP 4100 by a mapping unit 4104. The points on the HDMAP 4100 may be lane centerpoints. FIG. 5 is a diagram of an example 5000 of mapping GNSS coordinates, such as the GNSS coordinates of FIG. 4, to lane centerpoints of an HDMAP, such as the HDMAP 4100 of FIG. 4. The example 5000 illustrates a length of road 5002, which may represent the length of road 4002 of FIG. 4, that comprises one or more lanes—in this example 5000 there is a first lane 5008 and a second lane 5010. The length of road 5002 also comprises at least one road segment 5004—in this example 5000 there are a plurality of road segments including, for example road segment 5060; however, the length of road 5002 may comprise no road segments depending on, for example, the commercial provider of the HDMAP.

FIG. 5 illustrates a representative vehicle 5020, which may represent the vehicle 4020 of FIG. 4, traversing a path 5018 along the length of road 5002. Along the path 5018 are shown a plurality of GNSS coordinates, such as GNSS coordinates 5012a and 5012b. The plurality of GNSS coordinates may be obtained at regular or irregular intervals (in time), where regular intervals may be more common based on sensor hardware operation. The GNSS coordinates may each comprise a latitude coordinate, e.g., an x-coordinate, and a longitude coordinate, e.g., a y-coordinate (e.g., 2-dimensional GNSS coordinates). Some GNSS coordinates may comprise an altitude coordinate, e.g., a z-coordinate (e.g., 3-dimensional GNSS coordinates). An instance of GNSS coordinates may be referred to herein as a GNSS tuple, such as (x, y) or (x, y, z).

In some implementations, it may be advantageous to obtain the GNSS coordinates, or tuples, at a rate that yields an approximately one-to-one correspondence between lane centerpoints of a given lane and GNSS tuples. Accordingly, in some implementations, the mapping unit 4104 may determine a plurality of contiguous intervals 5006 of the HDMAP, wherein a length of each interval 5006 is a based on an expected acquisition rate of sensors of the ego vehicles 4020 for determining the GNSS tuples and an expected speed of vehicles on the length of road 4002; map each GNSS tuple to a respective interval 5040 of the plurality of contiguous intervals 5006; and map each GNSS tuple to a nearest lane centerpoint within the respective interval 5040. For example, the arrow 5014a in road segment id 0/interval id 1 indicates the mapping of the GNSS tuple 5012a to a lane centerpoint 5016a within that interval. In some cases, such as that indicated by the arrow 5014b in road segment 1/interval id 1, a GNSS tuple in one lane, such as GNSS tuple 5012b in lane 5010, may be mapped to a lane centerpoint in another lane, such as laner centerpoint 5016b in lane 5008. The mapping unit 4104 may filter out such outliers using statistical methods known in the art.

In some implementations, for vehicles operating at conventional highway speeds, such as 50-80 mph, and for commercially available HDMAPs, achieving an approximately one-to-one correspondence between lane centerpoints of a given lane and GNSS tuples corresponds to obtaining a GNSS tuple approximately every 10 m along the length of road 5002. Accordingly, in some implementations, the mapping unit 4104 may determine a plurality of contiguous intervals of the HDMAP 4100, wherein a length of each interval is approximately 10 meters; map each GNSS tuple to a respective interval of the plurality of contiguous intervals; and map each GNSS tuple to a nearest lane centerpoint within the respective interval.

Returning to FIG. 4, the mapping unit 4104 provides training data 4106 to the training unit 4108, where the training data 4106 comprises ego-vehicle speeds, lead-vehicle speeds, follow distances, and lane centerpoints. Specifically, the training data may comprise a time series of labeled data as {ego-vehicle speed, lead-vehicle speed, follow distance, and lane centerpoint} that describes the path and environment of the ego vehicle 4020 on the length of road 4002. The training unit 4108 is a computational framework designed to learn patterns, relationships, and/or behaviors from the data 4102, specifically, to determine an optimal speed 4110 for the future vehicle 4120 based on the training data 4106, where the optimal speed 4110 is a function of the training data 4106. To be clear, there may be multiple optimal speeds 4110 along the length of road 4002.

The training unit 4108 adjusts the ML model's internal parameters and improves its ability to perform a specific task, such as classification, regression, and/or prediction. The process may involve iteratively optimizing the ML model's parameters using techniques that may include, for example, gradient descent, genetic algorithms, simulated annealing, stochastic hill climbing, Newton's method, particle swarm optimization, evolution strategies, coordinate descent, quasi-Newton methods (e.g., Broyden-Fletcher-Goldfarb-Shanno), reinforcement learning optimization (e.g., policy gradient methods), and alternating direction method of multipliers (ADMM), to minimize a predefined loss function that measures the error between the ML model's predictions and the actual outcomes. The training unit 4108 may operate in supervised, unsupervised, or semi-supervised modes. The ML model may comprise one or more of linear regression, logistic regression, decision trees, random forests, support vector machines, k-nearest neighbors, naive Bayes, neural networks, convolutional neural networks (CNNs), deep learning models, gradient boosting machines, k-means clustering, principal component analysis, reinforcement learning models, and generative adversarial networks.

In some implementations, the training data 4106 may comprise additional parameters, or attributes, described by the HDMAP 4100, such as curvature of the length of road 4002, cross slope of the length of road 4002, along slope of the length of road 4002, lane type, lane width, lane length, and speed limit. Accordingly, the training unit 4108 may determine the optimal speed 4110 for the future vehicle 4120 based further on these additional parameters.

The optimal speed 4110 as a function of the training data may be implemented in an ACC system 4122 of the future vehicle 4120. For example, in some implementations, the optimal speed 4110 may be implemented as a lookup table that associates a plurality of speeds of the ego-vehicle speeds, a plurality of speeds of the lead-vehicle speeds, a plurality of distances of the follow distances, and a plurality of centerpoints of the lane centerpoints to respective optimal speeds 4110, where the ACC system 4122 is configured to adhere to a respective optimal speed based on a speed of the future vehicle 4120, a relative speed of a future lead vehicle ahead of the future vehicle 4120, a follow distance of the future vehicle 4120 to the future lead vehicle, and future lane centerpoints of the future vehicle 4120.

In some implementations, the optimal speed 4110 may be implemented by configuring a computing device in the future vehicle 4120 to implement the ML model for causing the ACC system 4122 of the future vehicle 4120 to adhere to the optimal speeds 4110 based on a speed of the future vehicle 4120, a relative speed of a future lead vehicle ahead of the future vehicle 4120, a follow distance of the future vehicle 4120 to the future lead vehicle, and future lane centerpoints of the future vehicle 4120.

In some implementations, the optimal speed 4110 may be implemented by configuring a computing device that is remote to the future vehicle 4120 to implement the ML model for causing the ACC system 4122 of the future vehicle 4120 to adhere to the optimal speeds 4110 based on a speed of the future vehicle 4120, a relative speed of a future lead vehicle ahead of the future vehicle 4120, a follow distance of the future vehicle 4120 to the future lead vehicle, and future lane centerpoints of the future vehicle 4120.

For simplicity of explanation, each technique, or process, is depicted and described herein as a series of steps or operations. However, the steps or operations of the techniques in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The technique 6000 described below is a technique for determining improved target (e.g., optimal) speeds for ACC systems of vehicles. This technique may be implemented by a system whose components may be internal and/or external to a vehicle, such as the controller 1300 of FIG. 1 or the computing apparatus 2410 of the data center 2400 of FIG. 2.

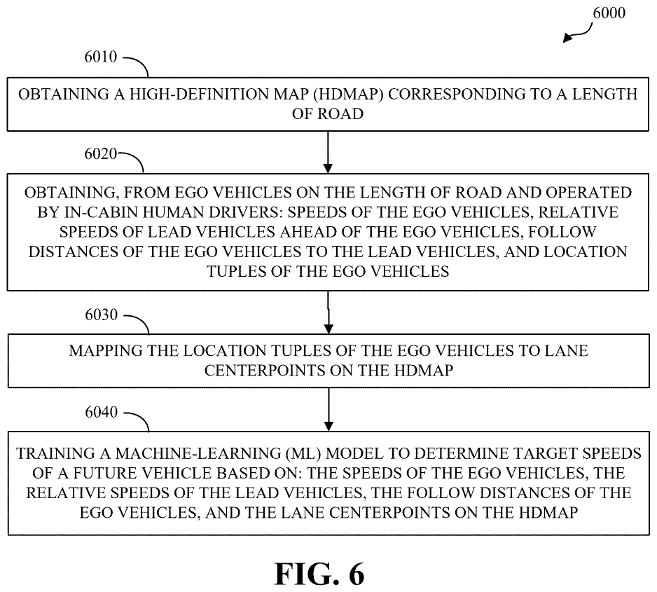

FIG. 6 is a flowchart of an example of a process for improved target (e.g., optimal) speeds for ACC systems of vehicles. The step 6010 comprises obtaining a high-definition map (HDMAP) corresponding to a length of road. The HDMAP may be the HDMAP 4100 of FIG. 4 and the length of road may be the length of road 4002 of FIG. 4.

The step 6020 comprises obtaining, from ego vehicles on the length of road and operated by in-cabin human drivers: speeds of the ego vehicles, relative speeds of lead vehicles ahead of the ego vehicles, follow distances of the ego vehicles to the lead vehicles, and location tuples of the ego vehicles. The ego vehicles may be instances of the vehicle 4020 of FIG. 4, the lead vehicles may be instances of the lead vehicle 4030 of FIG. 4, and the follow distances may be instances of the follow distance 4032 of FIG. 4. The speeds of the ego vehicles, relative speeds of lead vehicles ahead of the ego vehicles, follow distances of the ego vehicles to the lead vehicles, and location tuples of the ego vehicles may be instances of the data 4102 of FIG. 4.

In some implementations, the ego vehicles may obtain the speeds of the ego vehicles by VSSs. In some implementations, the ego vehicles may obtain the relative speeds of the lead vehicles by at least one of: lidar sensors; radar sensors; sonar sensors; ultrasonic sensors; infrared sensors; or optical cameras. In some implementations, the ego vehicles may obtain the follow distances of the ego vehicles by at least one of: lidar sensors; radar sensors; sonar sensors; ultrasonic sensors; infrared sensors; or optical cameras. In some implementations, the ego vehicles may obtain the location tuples by GNSS sensors. In some implementations, the location tuples are instances of the GNSS coordinates 5012a and 5012b of FIG. 5.

The step 6030 comprises mapping the location tuples of the ego vehicles to lane centerpoints on the HDMAP. In some implementations, the mapping is determined by a computational device, such as the mapping unit 4104 of FIG. 4. In some implementations, the lane centerpoints are instances of the lane centerpoints 5016a and 5016b of FIG. 5.

In some implementations, the process further comprises mapping the location tuples of the ego vehicles to the lane centerpoints on the HDMAP by: determining a plurality of contiguous intervals of the HDMAP, wherein a length of each interval is a based on an expected acquisition rate of sensors of the ego vehicles for determining the location tuples and an expected speed of vehicles on the length of road; mapping each location tuple to a respective interval of the plurality of contiguous intervals; and mapping each location tuple to a nearest lane centerpoint within the respective interval. The contiguous intervals may be the contiguous intervals 5006 of FIG. 5 and the respective interval may be the respective interval 5040 of FIG. 5.

In some implementations, the process further comprises determining a plurality of contiguous intervals of the HDMAP, wherein a length of each interval is approximately 10 meters; mapping each location tuple to a respective interval of the plurality of contiguous intervals; and mapping each location tuple to a nearest lane centerpoint within the respective interval. The contiguous intervals may be the contiguous intervals 5006 of FIG. 5 and the respective interval may be the respective interval 5040 of FIG. 5.

The step 6040 comprises training an ML model to determine target speeds of a future vehicle based on: the speeds of the ego vehicles, the relative speeds of the lead vehicles, the follow distances of the ego vehicles, and the lane centerpoints on the HDMAP. The future vehicle may be the future vehicle 41020 of FIG. 4, the target speeds may be instances of the target speed 4110 of FIG. 4, and the speeds of the ego vehicles, the relative speeds of the lead vehicles, the follow distances of the ego vehicles, and the lane centerpoints may be comprised in the training data 4106 of FIG. 4.

In some implementations, the process further comprises training the ML model with additional parameters, or attributes, described by the HDMAP, such as curvature of the length of road 4002, cross slope of the length of road 4002, along slope of the length of road 4002, lane type, lane width, lane length, and speed limit.

In some implementations, the process further comprises configuring a lookup table that associates a plurality of the speeds of the ego vehicles, a plurality of the relative speeds of the lead vehicles, a plurality of the follow distances of the ego vehicles, and a plurality of the lane centerpoints to respective target speeds; and configuring an ACC of the future vehicle to adhere to a respective target speed based on a speed of the future vehicle, a relative speed of a future lead vehicle ahead of the future vehicle, a follow distance of the future vehicle to the future lead vehicle, and future lane centerpoints of the future vehicle. The ACC may be the ACC system 4122 of FIG. 4.

In some implementations, the process further comprises configuring a computing device in the future vehicle to implement the ML model for causing a ACC of the future vehicle to adhere to the target speeds based on a speed of the future vehicle, a relative speed of a future lead vehicle ahead of the future vehicle, a follow distance of the future vehicle to the future lead vehicle, and future lane centerpoints of the future vehicle. The computing device in the future vehicle may be, for example, an instance of the computing device 3000 of FIG. 3.

In some implementations, the process further comprises configuring a computing device that is remote to the future vehicle to implement the ML model for causing an ACC of the future vehicle to adhere to the target speeds based on a speed of the future vehicle, a relative speed of a future lead vehicle ahead of the future vehicle, a follow distance of the future vehicle to the future lead vehicle, and future lane centerpoints of the future vehicle. The computing device in the future vehicle may be, for example, an instance of the computing apparatus 2410 of FIG. 2.

The above-described techniques can be implemented as a method, a system, and a non-transitory computer-readable medium, for example, as described below.

In an example implementation as a method, the method comprises: obtaining a high-definition map (HDMAP) corresponding to a length of road; obtaining, from ego vehicles on the length of road and operated by in-cabin human drivers: speeds of the ego vehicles, relative speeds of lead vehicles ahead of the ego vehicles, follow distances of the ego vehicles to the lead vehicles, and location tuples of the ego vehicles; mapping the location tuples of the ego vehicles to lane centerpoints on the HDMAP; and raining a machine-learning (ML) model to determine target speeds of a future vehicle based on: the speeds of the ego vehicles, the relative speeds of the lead vehicles, the follow distances of the ego vehicles, and the lane centerpoints on the HDMAP.

In some implementations, the method further comprises: configuring a lookup table that associates a plurality of the speeds of the ego vehicles, a plurality of the relative speeds of the lead vehicles, a plurality of the follow distances of the ego vehicles, and a plurality of the lane centerpoints to respective target speeds; and configuring an adaptive cruise control (ACC) of the future vehicle to adhere to a respective target speed based on a speed of the future vehicle, a relative speed of a future lead vehicle ahead of the future vehicle, a follow distance of the future vehicle to the future lead vehicle, and future lane centerpoints of the future vehicle.

In some implementations, the method further comprises: configuring a computing device in the future vehicle to implement the ML model for causing an adaptive cruise control (ACC) of the future vehicle to adhere to the target speeds based on a speed of the future vehicle, a relative speed of a future lead vehicle ahead of the future vehicle, a follow distance of the future vehicle to the future lead vehicle, and future lane centerpoints of the future vehicle.

In some implementations, the method further comprises: configuring a computing device that is remote to the future vehicle to implement the ML model for causing an adaptive cruise control (ACC) of the future vehicle to adhere to the target speeds based on a speed of the future vehicle, a relative speed of a future lead vehicle ahead of the future vehicle, a follow distance of the future vehicle to the future lead vehicle, and future lane centerpoints of the future vehicle.

In some implementations, the method further comprises: mapping the location tuples of the ego vehicles to the lane centerpoints on the HDMAP by: determining a plurality of contiguous intervals of the HDMAP, wherein a length of each interval is a based on an expected acquisition rate of sensors of the ego vehicles for determining the location tuples and an expected speed of vehicles on the length of road; mapping each location tuple to a respective interval of the plurality of contiguous intervals; and mapping each location tuple to a nearest lane centerpoint within the respective interval.

In some implementations, the method further comprises: mapping the location tuples of the ego vehicles to the lane centerpoints on the HDMAP by: determining a plurality of contiguous intervals of the HDMAP, wherein a length of each interval is approximately 10 meters; mapping each location tuple to a respective interval of the plurality of contiguous intervals; and mapping each location tuple to a nearest lane centerpoint within the respective interval.

In some implementations, the method further comprises: obtaining the speeds of the ego vehicles by vehicle speed sensors (VSSs).

In some implementations, the method further comprises: obtaining the relative speeds of the lead vehicles by at least one of: lidar sensors; radar sensors; sonar sensors; ultrasonic sensors; infrared sensors; or optical cameras.

In some implementations, the method further comprises: obtaining the follow distances of the ego vehicles by at least one of: lidar sensors; radar sensors; sonar sensors; ultrasonic sensors; infrared sensors; or optical cameras.

In some implementations, the method further comprises: obtaining the location tuples of the ego vehicles by global navigation satellite system (GNSS) sensors.

In some implementations, the method further comprises training the ML model based on curvatures of the length of road on the HDMAP.

In some implementations, the method further comprises training the ML model based on cross slopes of the length of road on the HDMAP.

In some implementations, the method further comprises training the ML model based on along slopes of the length of road on the HDMAP.

In some implementations, the method further comprises training the ML model based on lane widths of the length of road on the HDMAP.

In some implementations, the method further comprises training the ML model based on lane lengths of the length of road on the HDMAP.

In some implementations, the method further comprises training the ML model based on lane types of the length of road on the HDMAP.

In some implementations, the method further comprises training the ML model based on speed limits of the length of road on the HDMAP.

In another example implementation as a non-transitory computer-readable medium, the non-transitory computer-readable medium stores instructions operable to cause one or more processors to perform operations comprising: obtaining a high-definition map (HDMAP) corresponding to a length of road; obtaining, from ego vehicles on the length of road and operated by in-cabin human drivers: speeds of the ego vehicles, relative speeds of lead vehicles ahead of the ego vehicles, follow distances of the ego vehicles to the lead vehicles, and location tuples of the ego vehicles; mapping the location tuples of the ego vehicles to lane centerpoints on the HDMAP; and training a machine-learning (ML) model to determine target speeds of a future vehicle based on: the speeds of the ego vehicles, the relative speeds of the lead vehicles, the follow distances of the ego vehicles, and the lane centerpoints on the HDMAP.

In some implementations, the operations further comprise: configuring a computing device in the future vehicle to implement the ML model for causing an adaptive cruise control (ACC) of the future vehicle to adhere to the target speeds based on a speed of the future vehicle, a relative speed of a future lead vehicle ahead of the future vehicle, a follow distance of the future vehicle to the future lead vehicle, and future lane centerpoints of the future vehicle.

In another example implementation as a system, the system comprises one or more memories; and one or more processors configured to execute instructions stored in the one or more memories to: obtain a high-definition map (HDMAP) corresponding to a length of road; obtain, from ego vehicles on the length of road and operated by in-cabin human drivers: speeds of the ego vehicles, relative speeds of lead vehicles ahead of the ego vehicles, follow distances of the ego vehicles to the lead vehicles, and location tuples of the ego vehicles; map the location tuples of the ego vehicles to lane centerpoints on the HDMAP; and train a machine-learning (ML) model to determine target speeds of a future vehicle based on: the speeds of the ego vehicles, the relative speeds of the lead vehicles, the follow distances of the ego vehicles, and the lane centerpoints on the HDMAP.

As used herein, the terminology “example,” “embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

The above-described aspects, examples, and implementations have been described to allow easy understanding of the disclosure are not limiting. On the contrary, the disclosure covers various modifications and equivalent arrangements included within the scope of the appended claims, which scope is to be accorded the broadest interpretation to encompass all such modifications and equivalent structure as is permitted under the law.

What is claimed is:

1. A method, comprising:
obtaining a high-definition map (HDMAP) corresponding to a length of road;
obtaining, from ego vehicles on the length of road and operated by in-cabin human drivers:
speeds of the ego vehicles,
relative speeds of lead vehicles ahead of the ego vehicles,
follow distances of the ego vehicles to the lead vehicles, and
location tuples of the ego vehicles;
mapping the location tuples of the ego vehicles to lane centerpoints on the HDMAP; and
training a machine-learning (ML) model to determine target speeds of a future vehicle based on:
the speeds of the ego vehicles,
the relative speeds of the lead vehicles,
the follow distances of the ego vehicles, and
the lane centerpoints on the HDMAP.

2. The method of claim 1, further comprising:
configuring a lookup table that associates a plurality of the speeds of the ego vehicles, a plurality of the relative speeds of the lead vehicles, a plurality of the follow distances of the ego vehicles, and a plurality of the lane centerpoints to respective target speeds; and
configuring an adaptive cruise control (ACC) of the future vehicle to adhere to a respective target speed based on a speed of the future vehicle, a relative speed of a future lead vehicle ahead of the future vehicle, a follow distance of the future vehicle to the future lead vehicle, and future lane centerpoints of the future vehicle.

3. The method of claim 1, further comprising:
configuring a computing device in the future vehicle to implement the ML model for causing an adaptive cruise control (ACC) of the future vehicle to adhere to the target speeds based on a speed of the future vehicle, a relative speed of a future lead vehicle ahead of the future vehicle, a follow distance of the future vehicle to the future lead vehicle, and future lane centerpoints of the future vehicle.

4. The method of claim 1, further comprising:
configuring a computing device that is remote to the future vehicle to implement the ML model for causing an adaptive cruise control (ACC) of the future vehicle to adhere to the target speeds based on a speed of the future vehicle, a relative speed of a future lead vehicle ahead of the future vehicle, a follow distance of the future vehicle to the future lead vehicle, and future lane centerpoints of the future vehicle.

5. The method of claim 1, further comprising mapping the location tuples of the ego vehicles to the lane centerpoints on the HDMAP by:
determining a plurality of contiguous intervals of the HDMAP, wherein a length of each interval is a based on an expected acquisition rate of sensors of the ego vehicles for determining the location tuples and an expected speed of vehicles on the length of road;
mapping each location tuple to a respective interval of the plurality of contiguous intervals; and
mapping each location tuple to a nearest lane centerpoint within the respective interval.

6. The method of claim 1, further comprising mapping the location tuples of the ego vehicles to the lane centerpoints on the HDMAP by:
determining a plurality of contiguous intervals of the HDMAP, wherein a length of each interval is approximately 10 meters;
mapping each location tuple to a respective interval of the plurality of contiguous intervals; and
mapping each location tuple to a nearest lane centerpoint within the respective interval.

7. The method of claim 1, further comprising:
obtaining the speeds of the ego vehicles by vehicle speed sensors (VSSs).

8. The method of claim 1, further comprising obtaining the relative speeds of the lead vehicles by at least one of:
lidar sensors;
radar sensors;
sonar sensors;
ultrasonic sensors;
infrared sensors; or
optical cameras.

9. The method of claim 1, further comprising obtaining the follow distances of the ego vehicles by at least one of:
lidar sensors;
radar sensors;
sonar sensors;
ultrasonic sensors;
infrared sensors; or
optical cameras.

10. The method of claim 1, further comprising:
obtaining the location tuples of the ego vehicles by global navigation satellite system (GNSS) sensors.

11. The method of claim 1, further comprising training the ML model based on:
curvatures of the length of road on the HDMAP.

12. The method of claim 1, further comprising training the ML model based on:
cross slopes of the length of road on the HDMAP.

13. The method of claim 1, further comprising training the ML model based on:
along slopes of the length of road on the HDMAP.

14. The method of claim 1, further comprising training the ML model based on:
lane widths of the length of road on the HDMAP.

15. The method of claim 1, further comprising training the ML model based on:
lane lengths of the length of road on the HDMAP.

16. The method of claim 1, further comprising training the ML model based on:
lane types of the length of road on the HDMAP.

17. The method of claim 1, further comprising training the ML model based on:
speed limits of the length of road on the HDMAP.

18. A non-transitory computer-readable medium storing instructions operable to cause one or more processors to perform operations comprising:
obtaining a high-definition map (HDMAP) corresponding to a length of road;
obtaining, from ego vehicles on the length of road and operated by in-cabin human drivers:
speeds of the ego vehicles,
relative speeds of lead vehicles ahead of the ego vehicles,
follow distances of the ego vehicles to the lead vehicles, and
location tuples of the ego vehicles;
mapping the location tuples of the ego vehicles to lane centerpoints on the HDMAP; and
training a machine-learning (ML) model to determine target speeds of a future vehicle based on:
the speeds of the ego vehicles,
the relative speeds of the lead vehicles,
the follow distances of the ego vehicles, and
the lane centerpoints on the HDMAP.

19. The medium of claim 18, wherein the operations further comprise:
configuring a computing device in the future vehicle to implement the ML model for causing an adaptive cruise control (ACC) of the future vehicle to adhere to the target speeds based on a speed of the future vehicle, a relative speed of a future lead vehicle ahead of the future vehicle, a follow distance of the future vehicle to the future lead vehicle, and future lane centerpoints of the future vehicle.

20. A system, comprising:
one or more memories; and
one or more processors configured to execute instructions stored in the one or more memories to:
obtain a high-definition map (HDMAP) corresponding to a length of road;
obtain, from ego vehicles on the length of road and operated by in-cabin human drivers:
speeds of the ego vehicles,
relative speeds of lead vehicles ahead of the ego vehicles,
follow distances of the ego vehicles to the lead vehicles, and
location tuples of the ego vehicles;
map the location tuples of the ego vehicles to lane centerpoints on the HDMAP; and
train a machine-learning (ML) model to determine target speeds of a future vehicle based on:
the speeds of the ego vehicles,
the relative speeds of the lead vehicles,
the follow distances of the ego vehicles, and
the lane centerpoints on the HDMAP.
